(19) United States
(12) Patent Application Publication
(10) Pub. No.: US 2012/0029707 A1
(43) Pub. Date: Feb. 2, 2012

(54) SUPPLY WATER TEMPERATURE CONTROL APPARATUS AND METHOD THEREOF

(75) Inventors: Ryouta Dazai, Tokyo (JP); Hideaki Kugaya, Tokyo (JP)

(73) Assignee: YAMATAKE CORPORATION, Tokyo (JP)

(21) Appl. No.: 13/259,692

(22) PCT Filed: Mar. 18, 2010
(86) PCT No.: PCT/JP2010/054683

§ 371 Date: Sep. 23, 2011

(30) Foreign Application Priority Data
Mar. 31, 2009 (JP) 2009-085004

(51) Int. Cl. G05D 23/19; G06F 1/32; G05D 7/06

(52) U.S. Cl. 700/282

(57) ABSTRACT

A heat source device control apparatus (a supply water temperature control apparatus) periodically collects and accumulates, during the operation of a heat source device, the actual values of the amount of energy used by the heat source device, the amount of energy used by a cold/hot water pump, a supply water temperature of cold/hot water supplied from the heat source device and an outside air temperature as relevant parameters related to a current load situation. Every time when the relevant parameters are collected, the actual values of the relevant parameters thus collected are plotted in a multidimensional space, and a response surface model is created by the technology of RSM-S, then a current optimal supply water temperature is determined from the response surface model thus created.

### CROSS REFERENCE TO PRIOR APPLICATIONS

This application is a U.S. National Phase application under 35 U.S.C. §371 of International Application No. PCT/JP2010/054683, filed on Mar. 18, 2010 and claims benefit of priority to Japanese Patent Application No. 2009-085004, filed on Mar. 31, 2009. The International Application was published in Japanese on Oct. 7, 2010 as WO 2010/113660 A1 under PCT Article 21(2). All these applications are herein incorporated by reference.

### TECHNICAL FIELD

The present invention relates to a supply water temperature control apparatus and a method thereof for controlling the supply water temperature of cold/hot water supplied from a heat source device to a load device through a circulation pump.

### BACKGROUND

Conventionally, an air-conditioning control system using cold/hot water as a heating medium produces cold/hot water in a heat source device and supplies cold/hot water produced in this heat source device to a load device through a circulation pump. In such case, the supply water pressure of cold/hot water supplied from the heat source device to the load device is maintained at a constant level by controlling the power of the circulation pump.

In such air-conditioning control systems, for example, when the heat source device is a freezing machine, the cooling capacity of a load device decreases as the supply water temperature of cold water supplied from the freezing machine increases, and as a result, the demand flow rate of cold water increases. If the demand flow rate of cold water decreases, the supply water pressure increases, and as a result, the power of the circulation pump increases in order to maintain this supply water pressure at a constant level. On the other hand, an increase in the temperature of cold water to he produced improves the efficiency of a freezing machine, and as a result, the power of the freezing machine decreases. More specifically, an increase in the temperature of the supply water decreases the amount of energy used by a freezing machine, and increases the amount of energy used by a circulation pump.

In contrast, the cooling capacity of a load device increases as the supply water temperature of cold water supplied from the freezing machine decreases, and as a result, the demand flow rate of cold water decreases. If the demand flow rate of cold water decreases, the supply water pressure increases, and as a result, the power of the circulation pump decreases in order to maintain this supply water pressure at a constant level. On the other hand, a decrease in the temperature of cold water to be produced decreases the efficiency of a freezing machine, and as a result, the power of the freezing machine increases. More specifically, a decrease in the temperature of the supply water increases the amount of energy used by a freezing machine, and decreases the amount of energy used by a circulation pump.

As described above, the amount of energy used by a freezing machine or circulation pump varies depending on the setting of the supply water temperature of cold/hot water supplied from a freezing machine to a load device. If the supply water temperature is set to low, the amount of energy (the amount of power consumption) used by a circulation pump decreases as much as the amount of energy (the amount of power consumption or the amount of fuel consumption) used by a freezing machine increases. If the supply water temperature is set to high, the amount of energy (the amount of power consumption) used by a circulation pump increases as much as the amount of energy (the amount of power consumption or the amount of fuel consumption) used by a freezing machine decreases. More specifically, the amount of energy used by a freezing machine trades off against the amount of energy used by a circulation pump. The same holds true for the case where a heat source device is a heating machine.

If the supply water temperature can be set to a temperature at which the total amount of energy used by a heat source device and circulation pump reaches its minimum value, there will be no trade-off of the amounts of energy used by a freezing machine and a circulation pump, and an energy saving can be achieved. Focusing on such points, for example, JP2003-262384 A (“JP '384”) collects various parameter values related to a current load situation including a supply water temperature, a return water temperature, the flow rate of cold/hot water and the like, calculates the total amount of energy currently used by a heat source device and circulation pump by substituting the collected parameter values into a predetermined function model, and gradually varies the values of supply water temperatures in the function model used in this calculation, and thereby obtains the supply water temperature which corresponds to the current load situation where the total amount of energy used by a heat source device and circulation pump reaches its minimum value, and determines such supply water temperature as a current optimal supply water temperature.

Also see, JP2002-183111 A (“JR '111”).

However, according to the method of determining an optimal supply water temperature disclosed in JP '384, there was a problem that, due to the use of a fixed function model defined by rating characteristics and the like of a heat source device and circulation pump, such method could not cope with changes in the characteristics of the heat source device or circulation pump, or external environmental changes, and could not determine the optimal supply water temperature over a long period of time.

The present invention is made to solve such problem, and an object thereof is to provide a supply water temperature control apparatus and method thereof capable of coping with changes in the characteristics of a heat source device or circulation pump, or external environmental changes and determining continuously an optimal supply water temperature over a long period of time.

### SUMMARY OF THE INVENTION

In order to achieve such object, the present invention provides a supply water temperature control apparatus for controlling the supply water temperature of cold/hot water to be supplied from a heat source device to a load device through a circulation pump, the apparatus includes an actual value collection and accumulation means for periodically collecting and accumulating, during the operation of a heat source device, the actual values of the amount of energy used by the heat source device, the amount of energy used by the circulation pump, a supply water temperature, and a predetermined given parameter, as relevant parameters related to a current load situation; and optimal supply water temperature determination means for obtaining a supply water temperature which corresponds to the current load situation where the total amount of energy used by in-use devices including a heat source device and circulation pump reaches its minimum value, based on the actual values of the relevant parameters thus collected and accumulated by the actual value collection and accumulation means, and determining the supply water temperature thus obtained as a current optimal supply water temperature.

According to this invention, when an outside air temperature (tout) is used as a predetermined parameter in relevant parameters related to the current load situation, during the operation of a heat source device, the actual values of the amount of energy used (PW1) used by the heat source device, the amount of energy used (PW2) used by a circulation pump, a supply water temperature (TS), and the outside air temperature (tout) are periodically collected and accumulated. Then, based on these collected and accumulated actual values of relevant parameters, a supply water temperature which corresponds to the current load situation where the total amount of energy used by in-use devices including the heat source device and circulation pump reaches its minimum value is obtained, and the supply water temperature thus obtained is determined as a current optimal supply water temperature (TSsp).

As a method for such case, the collected actual values of relevant parameters are plotted in a multidimensional space, a response surface model is created by interpolating the actual values thus plotted in the multidimensional space, and a current optimal supply water temperature is determined from the response surface model thus created. For example, the collected actual values of the total amount of energy used PW used by the heat source device and circulation pump, the supply water temperature TS, and the outside air temperature tout are plotted in a three-dimensional space where the first axis represents the total amount of energy used PW (PW1+PW2) used by the heat source device and circulation pump, the second axis represents the supply water temperature TS, and the third axis represents the outside air temperature tout. The actual values thus plotted in the three-dimensional space are interpolated to create a response surface model (a three-dimensional stereoscopic model), the cross-section of the response surface model thus created is cut out by a current outside air temperature tout_{R}, a supply water temperature TS_{PWmin} at which the total amount of energy used PW reaches its minimum value is obtained in the cross-section of the response surface model thus cut out, and the supply water temperature TS_{PWmin} thus obtained is determined as a current optimal supply water temperature TSsp.

In the present example, in a system using a cooling tower, the amount of energy used by the fan of the cooling tower and the amount of energy used by a cooling water pump may be included in the total amount of energy used by in-use devices, and in a system using a secondary pump, the amount of energy used by the secondary pump and the like may be included in the total amount of energy used PW. Furthermore, in a system in which an air-conditioning machine adapts to variable air volume, the energy used by the air-conditioning machine and the like may be included in the total amount of energy used PW.

Additionally, in the present example, the predetermined parameter in relevant parameters related to the current load situation is not limited to the outside air temperature tout, and the number of the parameter is not limited to one. For example, two parameters, namely: the amount of heat load Q calculated from the supply water temperature TS, a return water temperature TR and the flow rate of cold/hot water F supplied to a load device; and the temperature of cooling water tC supplied to a heat source device may be used as predetermined parameters.

Furthermore, in the present example, the total amount of energy used may be the amount of energy converted into costs. For example, when the amount of energy used by a heat source device is the consumed amount of fuel such as gas, and when the amount of energy used by a circulation pump is the amount of power consumption, the amount of energy used by a heat source device and circulation pump are converted into costs (the amount of money) and then summed to be used as the total amount of energy used. Besides the cost equivalent values, the amount of CO₂ emissions, primary energy equivalent values, heavy oil equivalent values, and the like may possibly be used.

According to the present invention, during the operation of a heat source device, the actual values of the amount of energy used by the heat source device, the amount of energy used by a circulation pump, a supply water temperature and a predetermined given parameter are periodically collected and accumulated as relevant parameters related to a current load situation, a supply water temperature which corresponds to the current load situation where the total amount of energy used by in-use devices including the heat source device and circulation pump reaches its minimum value is obtained, based on the collected and accumulated actual values of relevant parameters, and the supply water temperature thus obtained is determined as a current optimal supply water temperature. Therefore, a function model such as a response surface model which continuously learns and grows on a real-time basis is used to cope with changes in the characteristics of a heat source device or circulation pump or external environmental changes, so that it is possible to continuously determine an optimal supply water temperature over a long period of time.

### BRIEF DESCRIPTION OF DRAWINGS

FIG. 1 is a diagram showing the main parts of one example of an air-conditioning control system having the supply water temperature control apparatus according to the present example.

FIG. 2 is a flowchart illustrating an optimal supply water temperature determination function contained in a heat source device control apparatus (a supply water temperature control apparatus) in this air-conditioning control system.

FIG. 3 is an image diagram showing a state where the actual values of relevant parameters are plotted in a three-dimensional space.

FIG. 4 is an image diagram showing a state where a response surface model is created from the actual values of relevant parameters plotted in a three-dimensional space by using multidimensional spline interpolation technology.

FIG. 5 is a diagram showing a state where the cross-section of a surface model is cut out by the current outside temperature tout_{R}.

FIG. 6 is a function block diagram illustrating a heat source device control apparatus in this air-conditioning control system.

### DETAILED DESCRIPTION

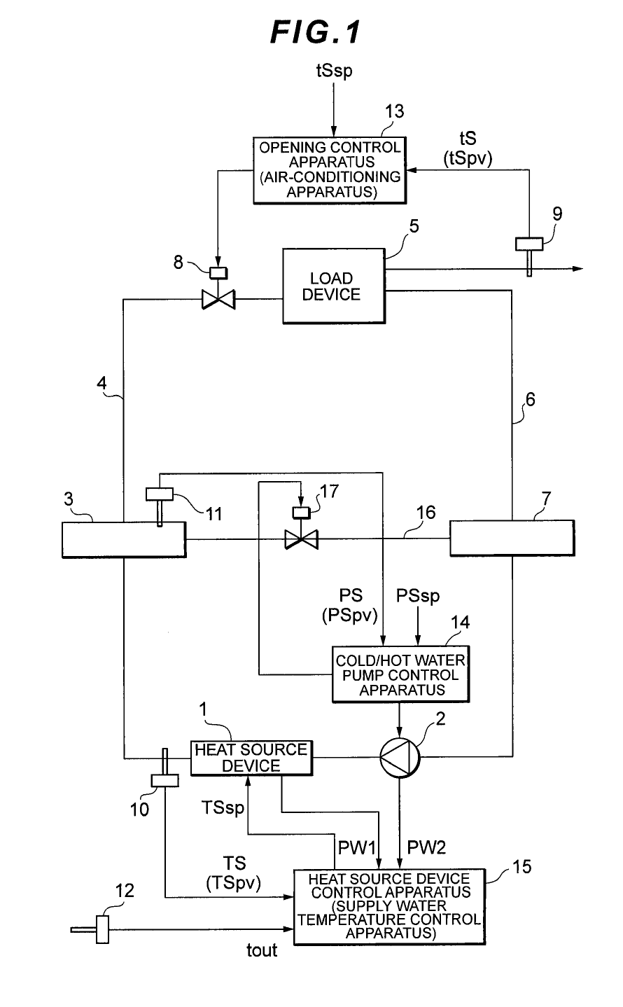

Hereinafter, examples of the present invention will be described in detail based on the embodiments. FIG. 1 is a diagram showing the main parts of one example of an air-conditioning control system having the supply water temperature control apparatus according to this invention.

In FIG. 1, the air-conditioning control system is configured to have a heat source device 1 producing cold/hot water; a cold/hot water pump (a circulation pump) 2 for conveying the cold/hot water produced by the heat source device 1; a supply header 3; a supply pipe line 4; a load device (air-conditioning machine) 5 receiving the supply of cold/hot water supplied from the supply header 3 through the supply pipe line 4; a return pipe line 6; a return header 7 to which the cold/hot water, which is heat-exchanged at the load device 5 and supplied through the return pipe line 6, is returned; and a flow rate control valve 8 provided in a supply passage for the cold/hot water from the supply header 3 to the load device 5.

The air-conditioning control system further has a charge air temperature sensor 9 measuring the temperature of charge air tS sending out from the load device 5 into a room; a supply water temperature sensor 10 measuring the outlet temperature of cold/hot water exiting from the heat source device 1 as the supply water temperature TS of cold/hot water supplied to the load device 5; a pressure sensor 11 measuring the pressure of cold/hot water at the supply header 3 as a supply water pressure PS of cold/hot water supplied from the heat source device 1 to the load device 5; an outside air temperature sensor 12 measuring the temperature of outside air as the outside air temperature tout; an opening control apparatus (an air-conditioning control apparatus) 13 controlling the opening of the flow rate control valve 8; a cold/hot water pump control apparatus 14 controlling the power of the cold/hot water pump 2; a heat source device control apparatus (a supply water temperature control apparatus) 15 controlling the power of the heat source device 1; a bypass pipe line 16 connecting the supply header 3 and the return header 7; and a bypass valve 17 provided in the bypass pipe line 16.

In this air-conditioning control system, the opening control apparatus 13 controls the opening of the flow rate control valve 8 such that the temperature of charge air tS (tSpv), which is sent into a room, to be measured by the charge air temperature sensor 9 matches a preset temperature tSsp. The cold/hot water pump control apparatus 14 controls the power of the cold/hot water pump 2 and the valve opening of the bypass valve 17 such that a supply water pressure PS (PSsv) of cold/hot water, which is supplied from the heat source device 1 to the load device 5, to be measured by the pressure sensor 11 is maintained at a preset value PSsp.

During the operation of the heat source device 1, the heat source device control apparatus 15 periodically collects and accumulates: the actual values of the amount of energy used (the amount of fuel consumption) PW1 used by the heat source device 1; the amount of energy used (the amount of power consumption) PW2 used by the cold/hot water pump 2; the supply water temperature TS of cold/hot water, which is supplied from the heat source device 1 to the load device 5, to be measured by the supply water temperature sensor 10; and the outside air temperature tout to be measured by the outside air temperature sensor 12, as relevant parameters related to the current load situation. Then, based on the actual values of the relevant parameters thus collected and accumulated, the heat source device control apparatus 15 obtains a supply water temperature TS_{PWmin} which corresponds to the current load situation where the total amount of energy used PW (PW1+PW2) used by the heat source device 1 and cold/hot water pump 2 reaches its minimum value, determines the supply water temperature TS_{PWmin} thus obtained as a current optimal supply water temperature TSsp, and transmits the optimal supply water temperature TSsp thus determined to the heat source device 1. The heat source device 1 receives the optimal supply water temperature TSsp from the heat source device control apparatus 15, and regulates its own capacity such that the outlet temperature of cold/hot water exiting from the heat source device 1 is in accord with the optimal value TSsp.

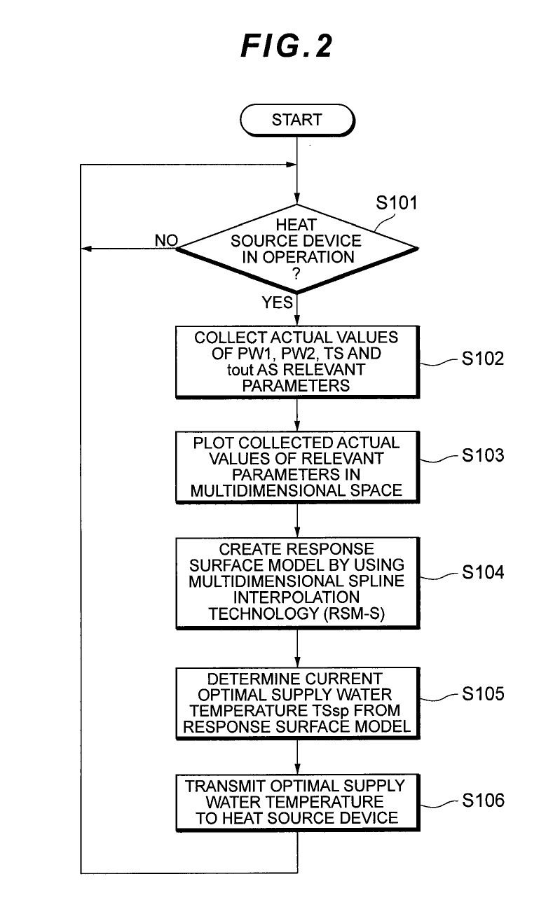

The heat source device control apparatus 15 includes hardware including a processor and storage device; and an optimal supply water temperature determination function, which is enabled by a program enabling various functions as a control apparatus in cooperation with these hardware, the summary of the function being described above as the unique function of the present example. Hereinafter, the optimal supply water temperature determination function contained in the heat source device control apparatus 15 will be described in detail in accordance with the flowchart illustrated in FIG. 2.

During the operation of the heat source device 1 (YES in step S101), the heat source device control apparatus 15 periodically repeats the process operations of step S102 and the subsequent steps. In step 3102, the heat source device control apparatus 15 collects the actual values of the amount of energy used (the amount of fuel consumption) PW1 used by the heat source device 1; the amount of energy used (the amount of power consumption) PW2 used by the cold/hot water pump 2; the supply water temperature TS (TSpv) of cold/hot water, which is supplied from the heat source device 1 to the load device 5, to be measured by the supply water temperature sensor 10; and the outside air temperature tout to be measured by the outside air temperature sensor 12, as relevant parameters related to the current load situation.

When collecting the actual values of these relevant parameters, the heat source device control apparatus 15 converts the amount of energy used (the amount of fuel consumption) PW1 used by the heat source device 1 and the amount of energy used (the amount of power consumption) PW2 used by the cold/hot water pump 2 into costs (the amount of money) and then sums them to be used as the total amount of energy used PW. Hereinafter, the example will be described on the condition where PW=PW1+PW2, and such total amount of energy used PW is a value converted into costs.

The heat source device control apparatus 15 plots the collected actual values of the total amount of energy used PW used by the heat source device 1 and the cold/hot water pump 2, the supply water temperature TS, and the outside air temperature tout in a three-dimensional space where the first axis represents the total amount of energy used PW (PW1+PW2) used by the heat source device 1 and cold/hot water pump 2, the second axis represents the supply water temperature TS, and the third axis represents the outside air temperature tout (step S103).

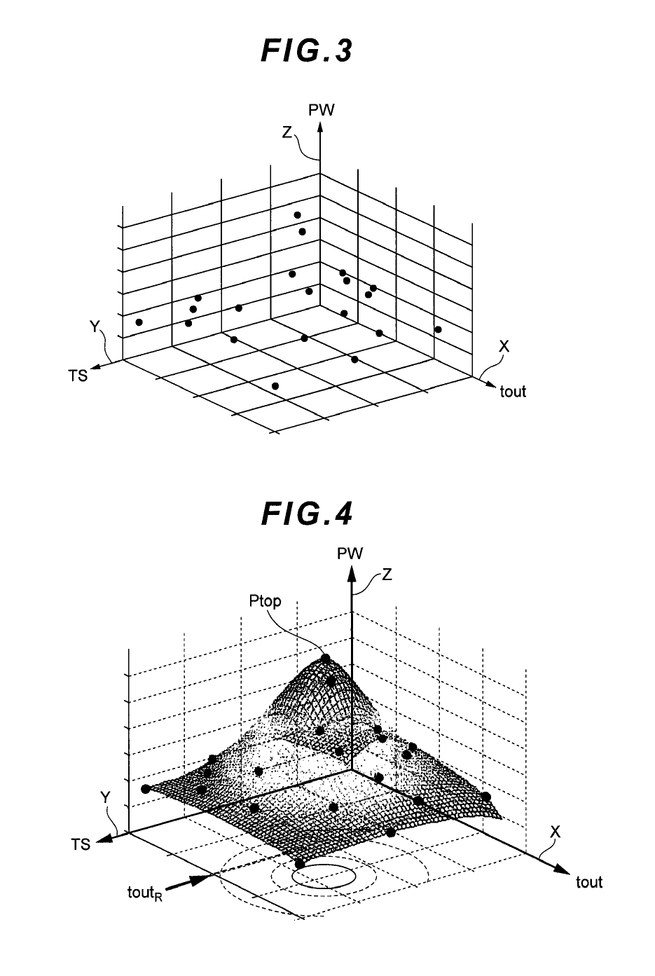

The image diagram of such case is shown in FIG. 3. In FIG. 3, the Z-axis is an axis (first axis) representing the total amount of energy used PW (PW1+PW2) used by the heat source device 1 and cold/hot water pump 2, the Y-axis is an axis (second axis) representing the supply water temperature TS, and the X-axis is an axis (third axis) representing the outside air temperature tout. In this example, the collected actual values of relevant parameters are accumulated in a memory in a manner where such actual values are plotted in this three-dimensional space.

Next, the heat source device control apparatus 15 creates a response surface model (a three-dimensional stereoscopic model) from the actual values of relevant parameters plotted in this three-dimensional space by using the multidimensional spline interpolation technology (step S104). Since the multidimensional spline interpolation technology is publicly known as RSM-S (for example, see JP '111), the detailed description thereof will be omitted herein.

The image diagram of such case is shown in FIG. 4. In FIG. 4, the Z-axis representing the total amount of energy used PW used by the heat source device 1 and the cold/hot water pump 2 is such that the more distant the value of such total amount of energy used PW is from the origin, the smaller the value is. In such case, a mountain-like shaped response surface model is created in the three-dimensional space, and the top Ptop of this response surface model is the point at which the total amount of energy used PW is estimated to reach its minimum value from past experience. More specifically, when the outside air temperature tout and the supply water temperature TS are at the point Ptop, the total amount of energy used PW used by the heat source device 1 and the cold/hot water pump 2 reaches its minimum value.

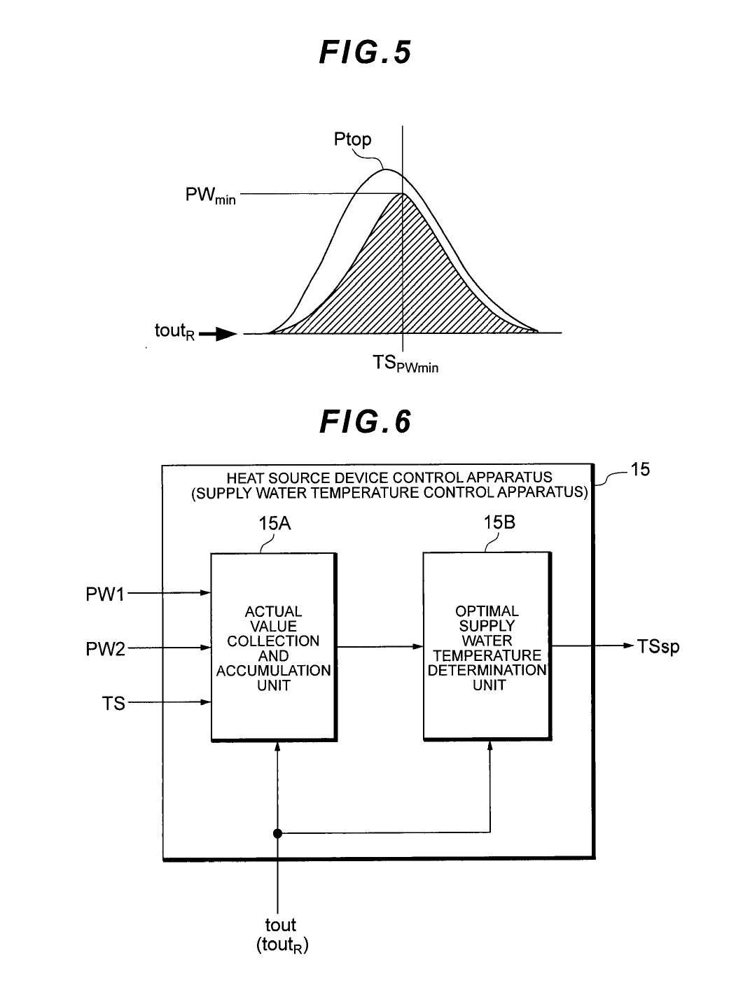

However, in this response surface model, an outside air temperature tout indicated by the point Ptop is not always a current outside aft temperature tout_{R}. Therefore, the heat source device control apparatus 15 cuts out the cross-section of this response surface model by the current outside air temperature tout_{R} (see FIG. 5), obtains a supply water temperature TS_{PWmin} at which the total amount of energy used PW reaches it minimum value in the cross-section of the response surface model thus cut out and determines the supply water temperature TS_{PWmin} thus obtained as a current optimal supply water temperature TSsp (step S105). Then, the heat source device control apparatus 15 transmits the current optimal supply water temperature TSsp thus determined to the heat source device 1 (step S106).

During the operation of the heat source device 1 (YES in step S101), the heat source device control apparatus 15 periodically repeats the process operations of steps S102 to S106 described above. Thus, in the present example, a function model such as a response surface model which continuously learns and grows on a real-time basis is used to cope with changes in the characteristics of the heat source device 1 or the cold/hot water pump 2 or external environmental changes, so that it is possible to continuously determine an optimal supply water temperature TSsp over a long period of time.

The function block diagram of the heat source device control apparatus 15 is shown in FIG. 6. The heat source device control apparatus 15 has an actual value collection and accumulation unit 15A periodically collecting and accumulating, during the operation of the heat source device 1, the actual values of the amount of energy used (the amount of fuel consumption) PW1 used by the heat source device 1, the amount of energy used (the amount of power consumption) PW2 used by the cold/hot water pump 2, the supply water temperature TS of cold/hot water supplied from the heat source device 1, and the outside air temperature tout as relevant parameters related to the current load situation; and an optimal supply water temperature determination unit 15B obtaining, every time when the relevant parameters are collected, a supply water temperature which corresponds to the current load situation where the total amount of energy used PW (PW1+PW2) used by the heat source device 1 and the cold/hot water pump 2 reaches its minimum value, based on the actual values of the relevant parameters thus collected and accumulated by the actual value collection unit 15A, and determining the supply water temperature thus obtained as a current optimal supply water temperature TSsp.

In this heat source device control apparatus 15, the optimal supply water temperature determination unit 15B plots the actual values of the relevant parameters (PW, TS, tout) collected by the actual value collection and accumulation unit 15A in a three-dimensional space, creates a response surface model from the actual values of the relevant parameters thus plotted by using the technology of RSM-S, cuts out the cross-section of this response surface model by the current outside air temperature tout_{R}, obtains the supply water temperature TS_{PWmin} at which the total amount of energy used PW reaches its minimum value in the cross-section of the response surface model thus cut out, and determines the supply water temperature TS_{PWmin} thus obtained as the current optimal supply water temperature TSsp.

In the above-described example, the total of the amounts of energy used by the heat source device 1 and the cold/hot water pump 2 is used as the total amount of energy used PW (PW1+PW2) used by in-use devices, however, in a system using a cooling tower, the amount of energy used PW3 used by the fan of the cooling tower and the amount of energy used PW4 used by a cooling water pump may be included in the total amount of energy used PW. Further, in a system using a secondary pump, the amount of energy used PW5 used by the secondary pump and the like may be included in the total amount of energy used PW. Furthermore, in a system in which an air-conditioning machine adapts to variable air volume, the energy used by the air-conditioning machine may be included in the total amount of energy used PW.

In the above-described example, the amount of energy used PW1 used by the heat source device 1, the amount of energy used PW2 used by the cold/hot water pump 2, the supply water temperature TS of cold/hot water supplied from the heat source device 1, and the outside air temperature tout are used as relevant parameters related to the current load situation, however, the outside air temperature does not have to be used, but instead other parameters may be used.

For example, in the system using a cooling tower, instead of the outside air temperature tout, the amount of heat load Q calculated from the supply water temperature TS, the return water temperature TR and the flow rate F of cold/hot water supplied to the load device 5, and the temperature tC of cooling water supplied to the heat source device 1 may be used as relevant parameters related to the current load situation. In such case, the actual values of the relevant parameters are plotted in a four-dimensional space where the first axis represents the total amount of energy used PW (PW1+PW2) used by the heat source device 1 and the cold/hot water pump 2, the second axis represents the supply water temperature TS, the third axis represents the amount of heat load Q, and the fourth axis represents the cooling water temperature tC, and a response surface model (a four-dimensional stereoscopic model) is created by interpolating the actual values thus plotted in this four-dimensional space with the technology of RSM-S. Besides these values, the flow rate of cooling water, the charge aft temperature of an air-conditioning machine, and a supply water pressure may be used as relevant parameters.

It should be noted that the four-dimensional space in such case is a virtual space on a computer. In such case, the response surface model is cut out by the amount of current heat load Q_{R} and the current cooling water temperature tC_{R}, the supply water temperature TS_{PWmin} at which the total amount of energy used PW reaches its minimum value is obtained in the cross-section of the response surface model thus cut out, and the supply water temperature TS_{PWmin} thus obtained is determined as the current optimal supply water temperature TSsp. Under a similar concept, as the number of relevant parameters related to the current load situation increases, the number of dimensions of a multidimensional space increases to a five-dimensional space, a six-dimensional space, and so on, and a response surface model is created from the actual values plotted in such multidimensional space by the technology of RSM-S, then the current optimal supply water temperature TSsp can be determined from the response surface model thus created.

Further, in the above-described example, the amount of energy used by the heat source device 1 and the cold/hot water pump 2 is converted into costs (the amount of money) and then summed to be used as the total amount of energy used PW, but, when the amount of energy used PW1 used by the heat source device 1 is the amount of power consumption, the total amount in which the amount of energy used PW1 used by the heat source device 1 and the amount of energy used PW2 used by the cold/hot water pump 2 are summed without being converted into costs may be used as the total amount of energy used PW. Additionally, even when the amount of energy used PW1 used by the heat source device 1 is the amount of power consumption, the amount of energy converted into costs may be used as the total amount of energy used PW. Furthermore, the amount of CO₂ emissions, primary energy equivalent values, heavy oil equivalent values, and the like may possibly be used as the total amount of energy used PW.

In addition, in the above-described example, the actual values of relevant parameters related to the current load situation are collected and accumulated, the actual values of the relevant parameters thus collected and accumulated are plotted in a multidimensional space, and a response surface model is created by the technology of RSM-S. However, such technology does not have to be used, but instead the invention may be such that a function model, which is the equivalent of the response surface model, is created from the periodically collected and accumulated actual values of the relevant parameters by other technologies and the current optimal supply water temperature TSsp is determined from the function model thus created.

Furthermore, the above-described example describes the case where the system has one heat source device 1, however, even in a system having more than one heat source device 1, optimal supply water temperatures TSsp of cold/hot water supplied from respective heat source devices 1 can be determined in a similar manner. In such case, the number of the supply water temperatures TS of cold/hot water supplied from respective heat source devices 1 increases, that is, the number of dimensions of a multidimensional space increases, but just one would suffice for the number of the response surface models to be created.

The supply water temperature control apparatus and the method thereof is applicable to various systems using a freezing machine (e.g. a chiller) or water heating machine as a supply water temperature control apparatus and a method thereof for controlling the supply water temperature of cold/hot water supplied from a heat source device to a load device through a circulation pump.

1. A supply water temperature control apparatus for controlling a supply water temperature of cold/hot water supplied from a heat source device to a load device through a circulation pump, the apparatus comprising:
an actual value collection and accumulation device, during operation of the heat source device, periodically collecting and accumulating actual values of an amount of energy used by the heat source device, an amount of energy used by the circulation pump, the supply water temperature, and a predetermined given parameter, as relevant parameters related to a current load situation; and
an optimal supply water temperature determination device, based on the actual values of the relevant parameters collected and accumulated by the actual value collection and accumulation device, obtaining a supply water temperature which corresponds to a current load situation where a total amount of energy used by in-⁻use devices including the heat source device and the circulation pump reaches its minimum value, and determining the supply water temperature thus obtained as a current optimal supply water temperature.

2. The supply water temperature control apparatus according to claim 1, wherein
the optimal supply water temperature determination device determines the current optimal supply water temperature from a response surface model created by plotting and interpolating the actual values of the relevant parameters collected by the actual value collection and accumulation device in a multidimensional space.

3. The supply water temperature control apparatus according to claim 1, wherein the total amount of energy used is an amount of energy converted into costs.

4. A method of controlling a supply water temperature for controlling a supply water temperature of cold/hot water supplied from a heat source device to a load device through a circulation pump, the method comprising the steps of:
an actual value collection and accumulation step, during operation of the heat source device, periodically collecting and accumulating actual values of an amount of energy used by the heat source device, an amount of energy used by the circulation pump, the supply water temperature, and a predetermined given parameter, as relevant parameters related to a current load situation; and
an optimal supply water temperature determination step, based on the actual values of the relevant parameters collected and accumulated in the actual value collection and accumulation step, obtaining a supply water temperature which corresponds to a current load situation where a total amount of energy used by in-use devices including the heat source device and the circulation pump reaches its minimum value, and determining the supply water temperature thus obtained as a current optimal supply water temperature.

5. The method of controlling a supply water temperature according to claim 4, wherein
the optimal supply water temperature determination step determines the current optimal supply water temperature from a response surface model created by plotting and interpolating the actual values of the relevant parameters collected in the actual value collection and accumulation step in a multidimensional space.

6. The method of controlling a supply water temperature according to claim 4, wherein the total amount of energy used is an amount of energy converted into costs.
